(19) United States
(12) Patent Application Publication
(10) Pub. No.: US 2025/0101148 A1
(43) Pub. Date: Mar. 27, 2025

(54) BIMODAL HDPE RESINS WITH IMPROVED ESCR AND PROCESSABILITY FOR CONDUIT, CABLE, BLOW MOLDING, AND OTHER END-USE APPLICATIONS

(71) Applicant: Chevron Phillips Chemical Company LP, The Woodlands, TX (US)

(72) Inventors: Vivek Rohatgi, Bartlesville, OK (US); David G. Hukill, Bartlesville, OK (US); Joseph A. Curren, Kingwood, TX (US); Jeffrey S. Fodor, Bartlesville, OK (US); Daniel G. Hert, Bartlesville, OK (US); Richard Brody Peterson, Bartlesville, OK (US)

(21) Appl. No.: 18/887,156

(22) Filed: Sep. 17, 2024

Related U.S. Application Data
(60) Provisional application No. 63/584,237, filed on Sep. 21, 2023.

(51) Int. Cl. C08F 10/02; C08L 23/06

(52) U.S. Cl. CPC C08F 10/02; C08L 23/06; C08F 2500/05; C08F 2500/07; C08F 2500/12; C08L 2205/03

(57) ABSTRACT

Ethylene-based polymers having a melt index from 0.15 to 0.5 g/10 min, a high load melt index from 15 to 50 g/10 min, a density from 0.94 to 0.96 g/cm³, and a higher molecular weight component and a lower molecular weight component are disclosed. The higher molecular weight component has a HMW HL275 from 3 to 8 g/10 min and a HMW density from 0.92 to 0.94 g/cm³. These polymers can have one or more of an environmental stress crack resistance (ESCR) of at least 1,000 hr, a yield strength of 3,000 to 5,000 psi, a viscosity at 100 sec⁻¹ of 1,000 to 1,800 Pa-sec, and/or a notched constant ligament stress (NCLS) of 80 to 1,000 hr.

### REFERENCE TO RELATED APPLICATION

This application claims the benefit of U.S. Provisional Patent Application No. 63/584,237, filed on Sep. 21, 2023, the disclosure of which is incorporated herein by reference in its entirety.

### FIELD OF THE INVENTION

The present disclosure generally relates to Ziegler-Natta catalyzed bimodal ethylene polymers having excellent stress crack resistance and improved processability, which can be utilized in a variety of wire, cable, conduit pipe, and related applications.

### BACKGROUND OF THE INVENTION

Polyolefins such as high density polyethylene (HDPE) homopolymer and copolymer and linear low density polyethylene (LLDPE) copolymer can be produced using various combinations of catalyst systems and polymerization processes for wire, cable, and conduit pipe (e.g., duct) applications, such as electrical power cables and telecommunications and data transmission cables. However, polymer resins for these applications can readily crack and fail under various environmental stresses. Further, high yield strength can be required, often necessitating the use of higher density polymers. Thus, there is a need for polyethylene resins with improved environmental stress crack resistance (ESCR), particularly at densities of 0.94 g/cm³ and above. Accordingly, it is to these ends that the present invention is generally directed.

### SUMMARY OF THE INVENTION

This summary is provided to introduce a selection of concepts in a simplified form that are further described herein. This summary is not intended to identify required or essential features of the claimed subject matter. Nor is this summary intended to be used to limit the scope of the claimed subject matter.

Disclosed herein are bimodal high density ethylene-based polymers having excellent processability, yield strength, stress crack resistance, and heat resistance. In an aspect, the ethylene polymers can have (or can be characterized by) a melt index (MI) in a range from 0.15 to 0.5 g/10 min, a high load melt index (HLMI) in a range from 15 to 50 g/10 min, a density in a range from 0.94 to 0.96 g/cm³, and a higher molecular weight component and a lower molecular weight component. The higher molecular weight component can have (or can be characterized by) a HMW HL275 in a range from 3 to 8 g/10 min and a HMW density in a range from 0.92 to 0.94 g/cm³.

These ethylene polymers can be used to produce various articles of manufacture, such as for wire, cable, conduit pipe, and related end-use applications.

Both the foregoing summary and the following detailed description provide examples and are explanatory only. Accordingly, the foregoing summary and the following detailed description should not be considered to be restrictive. Further, features or variations can be provided in addition to those set forth herein. For example, certain aspects can be directed to various feature combinations and sub-combinations described in the detailed description.

### BRIEF DESCRIPTION OF THE FIGURES

FIG. 1 presents a plot of the molecular weight distributions of the polymers of Inventive Examples 1-4.

FIG. 2 presents a plot of heat deflection temperature (ASTM D648, 66 psi) versus polymer density.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and/or feature disclosed herein, all combinations that do not detrimentally affect the polymers and/or compositions described herein are contemplated with or without explicit description of the particular combination. Additionally, unless explicitly recited otherwise, any aspect and/or feature disclosed herein can be combined to describe inventive features consistent with the present disclosure.

Generally, groups of elements are indicated using the numbering scheme indicated in the version of the periodic table of elements published in Chemical and Engineering News, 63 (5), 27, 1985. In some instances, a group of elements can be indicated using a common name assigned to the group; for example, alkali metals for Group 1 elements, alkaline earth metals for Group 2 elements, transition metals for Group 3-12 elements, and halogens or halides for Group 17 elements.

For any particular compound disclosed herein, the general structure or name presented is also intended to encompass all structural isomers, conformational isomers, and stereoisomers that can arise from a particular set of substituents, unless indicated otherwise. Thus, a general reference to a compound includes all structural isomers unless explicitly indicated otherwise; e.g., a general reference to pentane includes n-pentane, 2-methyl-butane, and 2,2-dimethylpropane, while a general reference to a butyl group includes an n-butyl group, a sec-butyl group, an iso-butyl group, and a tert-butyl group. Additionally, the reference to a general structure or name encompasses all enantiomers, diastereomers, and other optical isomers whether in enantiomeric or racemic forms, as well as mixtures of stereoisomers, as the context permits or requires. For any particular formula or name that is presented, any general formula or name presented also encompasses all conformational isomers, regioisomers, and stereoisomers that can arise from a particular set of substituents.

The terms “a,” “an,” “the,” etc., are intended to include plural alternatives, e.g., at least one, unless otherwise specified.

The terms “contacting” and “combining” are used herein to describe compositions and processes/methods in which the materials are contacted or combined together in any order, in any manner, and for any length of time, unless otherwise specified. For example, the materials can be blended, mixed, slurried, dissolved, reacted, treated, impregnated, compounded, or otherwise contacted or combined in some other manner or by any suitable method or technique.

The term “hydrocarbon” refers to a compound containing only carbon and hydrogen. Other identifiers can be utilized to indicate the presence of particular groups in the hydrocarbon (e.g., halogenated hydrocarbon indicates the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Non-limiting examples of hydrocarbyl groups include alkyl, alkenyl, aryl, and aralkyl groups, amongst other groups.

The term “polymer” is used herein generically to include olefin homopolymers, copolymers, terpolymers, and the like, as well as alloys and blends thereof. The term “polymer” also includes impact, block, graft, random, and alternating copolymers. A copolymer is derived from an olefin monomer and one olefin comonomer, while a terpolymer is derived from an olefin monomer and two olefin comonomers. Accordingly, “polymer” encompasses copolymers and terpolymers derived from any olefin monomer and comonomer(s) disclosed herein. Similarly, the scope of the term “polymerization” includes homopolymerization, copolymerization, and terpolymerization. Therefore, an ethylene polymer includes ethylene homopolymers, ethylene copolymers (e.g., ethylene/α-olefin copolymers), ethylene terpolymers, and the like, as well as blends or mixtures thereof. Thus, an ethylene polymer encompasses polymers often referred to in the art as LLDPE (linear low density polyethylene) and HDPE (high density polyethylene). As an example, an ethylene copolymer can be derived from ethylene and a comonomer, such as 1-butene, 1-hexene, or 1-octene. If the monomer and comonomer were ethylene and 1-hexene, respectively, the resulting polymer can be categorized an as ethylene/1-hexene copolymer. The term “polymer” also includes all possible geometrical configurations, unless stated otherwise, and such configurations can include isotactic, syndiotactic, and random symmetries. Moreover, unless stated otherwise, the term “polymer” also is meant to include all molecular weight polymers and is inclusive of lower molecular weight polymers.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. For example, the ethylene polymer can have various ratios of Mw/Mn in aspects of this invention. By a disclosure that the ratio of Mw/Mn is in a range from 10 to 20, the intent is to recite that the ratio of Mw/Mn can be any ratio in the range and, for example, can include any range or combination of ranges from 10 to 20, such as from 11 to 19, from 12 to 20, from 12 to 19, from 12 to 18, from 13 to 20, from 13 to 19, or from 13 to 18, and so forth. Likewise, all other ranges disclosed herein should be interpreted in a manner similar to this example.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods and materials similar or equivalent to those described herein can be used in the practice or testing of the invention, the typical methods and materials are herein described.

All publications and patents mentioned herein are incorporated herein by reference in their entirety for the purpose of describing and disclosing, for example, the constructs and methodologies that are described in the publications and patents, which might be used in connection with the presently described invention.

### DETAILED DESCRIPTION OF THE INVENTION

The present disclosure is directed generally to polymer resins produced using Ziegler-Natta catalyst systems and articles of manufacture formed from these polymer resins. While polymers having a relatively high density and melt flow rate (for improved extrusion processability) often have poor environmental stress crack resistance (ESCR), the bimodal ethylene polymers described herein have an advantageous combination of high density, high ESCR, and excellent processability.

Another objective of this invention is for the ethylene polymer to have a relatively high density, which translates in part to excellent mechanical properties, such as high yield strength, tensile modulus, and notched constant ligament stress (NCLS), as well as higher puller speeds.

Another objective of this invention is for the ethylene polymer to have excellent processability for high extrusion throughput, often quantified by a relatively high melt index (and/or high load melt index) and a relatively low viscosity at 100 sec⁻¹. Output or throughput increases of up to 15% can be achieved due to the improved processability (e.g., lower die backpressure).

Another objective of this invention is for the ethylene polymer to have excellent processability for high extrusion throughput in combination with a relatively high density and heat deflection temperature (for instance, over 65° C. or over 70° C.) and/or thermal stability (for instance, over 240° C. or over 250° C.), and unexpectedly high ESCR values.

### Ethylene Polymers

Generally, the polymers disclosed herein are ethylene-based polymers, or ethylene polymers, encompassing homopolymers of ethylene as well as copolymers, terpolymers, etc., of ethylene and at least one olefin comonomer. Comonomers that can be copolymerized with ethylene often can have from 3 to 20 carbon atoms in their molecular chain. For example, typical comonomers can include, but are not limited to, propylene, 1-butene, 1-pentene, 1-hexene, 1-heptene, 1-octene, and the like, or combinations thereof. In an aspect, the olefin comonomer can comprise a C₃-C₁₈ olefin; alternatively, the olefin comonomer can comprise a C₃-C₁₀ olefin; alternatively, the olefin comonomer can comprise a C₄-C₁₀ olefin; alternatively, the olefin comonomer can comprise a C₃-C₁₀ α-olefin; alternatively, the olefin comonomer can comprise a C₄-C₁₀ α-olefin; alternatively, the olefin comonomer can comprise 1-butene, 1-hexene, 1-octene, or any combination thereof; or alternatively, the comonomer can comprise 1-hexene. Typically, the amount of the comonomer, based on the total weight of monomer (ethylene) and comonomer, can be in a range from 0.01 to 20 wt. %, from 0.01 to 1 wt. %, from 0.5 to 15 wt. %, from 0.5 to 2 wt. %, or from 1 to 15 wt. %.

In one aspect, the ethylene polymer of this invention can comprise an ethylene/α-olefin copolymer, while in another aspect, the ethylene polymer can comprise an ethylene homopolymer, and in yet another aspect, the ethylene polymer of this invention can comprise an ethylene/α-olefin copolymer and an ethylene homopolymer. For example, the ethylene polymer can comprise an ethylene/1-butene copolymer, an ethylene/1-hexene copolymer, an ethylene/1-octene copolymer, an ethylene homopolymer, or any combination thereof; alternatively, an ethylene/1-butene copolymer, an ethylene/1-hexene copolymer, an ethylene/1-octene copolymer, or any combination thereof; or alternatively, an ethylene/1-hexene copolymer.

An illustrative and non-limiting example of an ethylene polymer (e.g., comprising an ethylene copolymer) consistent with the present invention can have (or can be characterized by) a melt index (MI) in a range from 0.15 to 0.5 g/10 min, a high load melt index (HLMI) in a range from 15 to 50 g/10 min, a density in a range from 0.94 to 0.96 g/cm³, and a higher molecular weight component and a lower molecular weight component. The higher molecular weight component can have (or can be characterized by) a HMW HL275 in a range from 3 to 8 g/10 min and a HMW density in a range from 0.92 to 0.94 g/cm³. This illustrative and non-limiting example of an ethylene polymer consistent with the present invention also can have any of the polymer properties listed below and in any combination, unless indicated otherwise.

The melt index (MI or I₂) of ethylene polymers encompassed herein, in some aspects, can be in a range from 0.15 to 0.45 g/10 min, from 0.15 to 0.4 g/10 min, from 0.2 to 0.5 g/10 min, from 0.2 to 0.4 g/10 min, from 0.2 to 0.35 g/10 min, from 0.25 to 0.5 g/10 min, from 0.25 to 0.45 g/10 min, from 0.25 to 0.4 g/10 min, from 0.27 to 0.5 g/10 min, from 0.27 to 0.45 g/10 min, from 0.27 to 0.4 g/10 min, or from 0.3 to 0.4 g/10 min. Additionally or alternatively, the high load melt index (HLMI or I₂₁) of these ethylene polymers often can range from 15 to 45 g/10 min or from 20 to 50 g/10 min, such as from 15 to 40 g/10 min, from 20 to 45 g/10 min, from 20 to 40 g/10 min, from 25 to 50 g/10 min, from 25 to 45 g/10 min, from 25 to 40 g/10 min, from 27 to 45 g/10 min, or from 27 to 40 g/10 min. Additionally or alternatively, the I₅ of these ethylene polymers generally ranges from 0.8 to 2.4 g/10 min, from 1 to 2.2 g/10 min, from 1 to 2 g/10 min, or from 1 to 1.8 g/10 min in one aspect, and from 1.1 to 2.2 g/10 min, from 1.1 to 2 g/10 min, or from 1.1 to 1.9 g/10 min in another aspect, and from 1.2 to 2 g/10 min, from 1.2 to 1.9 g/10 min, or from 1.2 to 1.8 g/10 min in yet another aspect, and from 1.3 to 2.2 g/10 min, from 1.3 to 2 g/10 min, from 1.3 to 1.9 g/10 min, or from 1.3 to 1.8 g/10 min in still another aspect.

The ratio of HLMI/MI of the ethylene polymer can fall within a range from 80 to 130, from 85 to 125, from 85 to 120, from 85 to 115, or from 90 to 130 in some aspects, while in other aspects, the ratio of HLMI/MI of these polymers can range from 90 to 125; alternatively, from 90 to 120; alternatively, from 90 to 115; alternatively, from 95 to 125; alternatively, from 95 to 120; or alternatively, from 95 to 115.

The densities of these ethylene-based polymers are greater than or equal to 0.94 g/cm³ and less than or equal to 0.96 g/cm³. Representative ranges for the density of these polymers can include from 0.94 to 0.958 g/cm³, from 0.94 to 0.954 g/cm³, from 0.945 to 0.96 g/cm³, from 0.945 to 0.958 g/cm³, from 0.945 to 0.954 g/cm³, from 0.947 to 0.958 g/cm³, from 0.947 to 0.954 g/cm³, from 0.949 to 0.958 g/cm³, from 0.949 to 0.955 g/cm³, or from 0.949 to 0.953 g/cm³, and the like.

In an aspect, these ethylene polymers can have a number-average molecular weight (Mn) in a range from 7,000 to 16,000 g/mol, such as from 8,000 to 15,000 g/mol, from 9,000 to 15,000 g/mol, from 9,000 to 14,000 g/mol, or from 10,000 to 14,000 g/mol, and the like. While not limited thereto, these ethylene polymers can have a weight-average molecular weight (Mw) in a range from 150,000 to 280,000 g/mol, from 150,000 to 250,000 g/mol, from 150,000 to 225,000 g/mol, from 160,000 to 260,000 g/mol, from 160,000 to 240,000 g/mol, from 160,000 to 220,000 g/mol, from 170,000 to 260,000 g/mol, from 170,000 to 220,000 g/mol, from 180,000 to 250,000 g/mol, from 180,000 to 225,000 g/mol, or from 180,000 to 205,000 g/mol. Additionally or alternatively, these ethylene polymers can have a z-average molecular weight (Mz) in a range from 700,000 to 1,900,000 g/mol, from 800,000 to 1,800,000 g/mol, from 850,000 to 1,750,000 g/mol, from 900,000 to 1,700,000 g/mol, from 950,000 to 1,650,000 g/mol, or from 1,000,000 to 1,600,000 g/mol.

In an aspect, the ethylene polymers can have a ratio of Mw/Mn, or the polydispersity index, in a range from 10 to 20, such as from 11 to 20, from 11 to 19, from 12 to 20, from 12 to 19, from 12 to 18, from 13 to 20, from 13 to 19, or from 13 to 18, and the like. Additionally or alternatively, these ethylene polymers can have a ratio of Mz/Mw in a range from 4 to 10, from 4 to 9, from 4 to 8, from 4.5 to 10, from 4.5 to 9, from 4.5 to 8.5, from 4.5 to 8, from 5 to 10, from 5 to 9, from 5 to 8, from 5.25 to 9, from 5.25 to 8, from 5.5 to 9, or from 5.5 to 8, and the like.

In accordance with certain aspects of this invention, the IB parameter from a molecular weight distribution curve (plot of dW/d (Log M) vs. Log M; normalized to an area equal to 1) can be an important characteristic of the ethylene polymers described herein. The IB parameter is often referred to as the integral breadth, and is defined as 1/[dW/d(Log M)]_{MAX}, and is useful to describe the shape of the largest peak in a bimodal MWD: the largest peak is smaller/broader as the IB parameter increases. Generally, the IB parameter of the ethylene polymers consistent with this invention can, in one aspect, be in a range from 1.7 to 2.4. In another aspect, the ethylene polymer can be characterized by an IB parameter in a range from 1.7 to 2.3 or from 1.7 to 2.2, and in another aspect, the IB parameter can range from 1.8 to 2.3 or from 1.8 to 2.2, and in another aspect, the IB parameter can range from 1.8 to 2.1 or from 1.9 to 2.3, and in another aspect, the IB parameter can range from 1.9 to 2.2 or from 2 to 2.4, and in yet another aspect, the IB parameter can range from 2 to 2.3 or from 2 to 2.2, and in still another aspect, the IB parameter can range from 2 to 2.1.

In an aspect, these ethylene polymers can have a CY-a parameter in a range from 0.18 to 0.33. Other suitable ranges for the CY-a parameter include, but are not limited to, from 0.2 to 0.32, from 0.2 to 0.3, from 0.22 to 0.3, from 0.24 to 0.3, from 0.24 to 0.28, or from 0.25 to 0.28, and the like. Additionally or alternatively, these ethylene polymers can have a relaxation time (Tau(eta) or τ(η)) in a range from 0.1 to 0.8 sec. Other suitable ranges for the relaxation time include, but are not limited to, from 0.2 to 0.7, from 0.2 to 0.6, from 0.3 to 0.7, from 0.3 to 0.6, or from 0.3 to 0.5 sec. A polymer relaxation time typically refers to the time it takes the polymer chains to return to equilibrium after being disturbed. Non-Newtonian fluids have a characteristic memory time scale which is referred to as the relaxation time. When the applied rate of deformation is reduced to zero, these materials relax over their characteristic relaxation time. A low Tau(eta) value is desirable because it corresponds to minimized stresses in the polymer during orientation such as in a cable or pipe processing. Generally, Tau(eta) increases with molecular weight, however, the entanglements of the polymer, the long chain branching, the molecular weight, and the molecular weight distribution all influence the relaxation behavior. While not limited thereto, the ethylene polymers can have a zero-shear viscosity (no) that generally ranges from 40,000 to 140,000 Pa-sec, and other illustrative ranges include from 50,000 to 130,000 Pa-sec, from 50,000 to 110,000 Pa-sec, from 50,000 to 100,000 Pa-sec, from 60,000 to 120,000 Pa-sec, from 60,000 to 100,000 Pa-sec, from 60,000 to 90,000 Pa-sec, or from 70,000 to 85,000 Pa-sec. The CY-a, relaxation time, and zero-shear viscosity parameters are determined from viscosity data measured at 190° C. and using the Carreau-Yasuda (CY) empirical model described herein.

While not limited thereto, the ethylene polymer can have a tan δ (tan d or tangent delta) at 0.1 sec⁻¹ in a range from 1.8 to 3.2 degrees. Other suitable ranges for the tan δ at 0.1 sec⁻¹ include, but are not limited to, from 2 to 3, from 2.1 to 2.8, from 2.1 to 2.7, from 2.2 to 2.7, from 2.3 to 2.7, or from 2.3 to 2.6 degrees, and the like. The (low frequency) tan δ at 0.1 sec⁻¹ of greater than 1, as opposed to less than 1, is indicative of a polymer with relatively low elasticity at low shear, which can be beneficial for certain end-use applications, such as cable and pipe applications. Additionally or alternatively, these ethylene polymers can have a tan δ (tan d or tangent delta) at 100 sec⁻¹ that falls within a range from 0.5 to 1 degrees, and more often, from 0.5 to 0.9, from 0.6 to 1, from 0.6 to 0.9, from 0.6 to 0.8, from 0.65 to 0.9, from 0.65 to 0.8, from 0.7 to 0.9, or from 0.7 to 0.8 degrees, although not limited thereto. The tan & rheological parameters are determined from viscosity data measured at 190° C. and using the Carreau-Yasuda (CY) empirical model described herein.

Additionally or alternatively, these ethylene polymers can have a viscosity at 100 sec⁻¹ (eta@100 or η@100) in a range from 1,000 to 1,800 Pa-sec, such as from 1,100 to 1,700 Pa-sec or from 1,200 to 1,800 Pa-sec. In some aspects, the viscosity at 100 sec⁻¹ of the ethylene polymer can falls within a range from 1,100 to 1,600; alternatively, from 1,100 to 1,500; alternatively, from 1,200 to 1,700; alternatively, from 1,200 to 1,600; alternatively, from 1,200 to 1,500; alternatively, from 1,300 to 1,700; alternatively, from 1,300 to 1,600; or alternatively, from 1,300 to 1,500 Pa-sec. Further, the ethylene polymer can have a ratio of η@0.1/η@100 at 190° C. (ratio of viscosity at 0.1 sec⁻¹ to the viscosity at 100 sec⁻¹) in a range from 14 to 24; alternatively, from 15 to 22; alternatively, from 16 to 21; alternatively, from 17 to 20; or alternatively, from 18 to 19. The viscosity and the ratio are both determined from the CY model at 190° C.

Advantageously, the ethylene polymers have excellent stress crack resistance, particularly surprising given the relatively high polymer densities. In an aspect of this disclosure, these polymers can have an environmental stress crack resistance (ESCR) of at least 1,000 hr (ASTM D1693, condition B, 10% Igepal), and more typically, an ESCR of at least 1,500 hr, or at least 2,000 hr. Unexpectedly, these polymers often can have an ESCR of at least 2,500 hr, at least 2,800 hr, at least 3,000 hr, or at least 3,500 hr (under condition B, 10% Igepal). The ESCR test is typically stopped after a certain number of hours is reached, and given the long duration of the test, the upper limit of ESCR (in hr) is generally not determined.

As disclosed herein, the ethylene polymer can have a high or higher molecular weight (HMW) component (or a first component) and a low or lower molecular weight (LMW) component (or a second component). These component terms are relative, are used in reference to each other, and are not limited to the actual molecular weights of the respective components. Generally, the higher molecular weight component (HMW) component can have (or can be characterized by) a HMW HL275 in a range from 3 to 8 g/10 min and a HMW density in a range from 0.92 to 0.94 g/cm³. In this context, the HMW component is produced is a first reactor, and the LMW component is produced in a second reactor. The HMW component, which is discharged from the first reactor and introduced into the second reactor, can be readily tested for its polymer attributes. The HMW HL275 of the higher molecular weight component typically can fall within a range of from 3 to 7 g/10 min or from 4.2 to 8 g/10 min. Other representative and non-limiting ranges for the HL275 include from 3 to 6.5 g/10 min, from 3.5 to 7.5 g/10 min, from 3.5 to 7 g/10 min, from 3.5 to 6.5 g/10 min, from 4 to 7.5 g/10 min, from 4 to 7 g/10 min, from 4.2 to 7.5 g/10 min, from 4.2 to 7 g/10 min, from 4.2 to 6.5 g/10 min, from 4.5 to 8 g/10 min, from 4.5 to 7.5 g/10 min, from 4.5 to 7 g/10 min, from 4.5 to 6.5 g/10 min, or from 4.9 to 6.1 g/10 min, and the like. Additionally, the HMW density (the density of the HMW component that is discharged from the first reactor) is greater than or equal to 0.92 g/cm³ and less than or equal to 0.94 g/cm³. Representative and non-limiting ranges for the HMW density can include from 0.92 to 0.935 g/cm³, from 0.925 to 0.94 g/cm³, from 0.925 to 0.938 g/cm³, from 0.925 to 0.935 g/cm³, from 0.928 to 0.94 g/cm³, from 0.928 to 0.938 g/cm³, from 0.928 to 0.935 g/cm³, from 0.93 to 0.94 g/cm³, from 0.93 to 0.938 g/cm³, or from 0.93 to 0.935 g/cm³, and the like.

From the HL275 values, the (calculated) HLMI of the HMW component can be determined. The HLMI can be calculated from the HL275 based on Equation 1: HLMI=HL275/3.2 (Eq. 1). While not limited thereto, the (calculated) HLMI of the HMW component can range from 0.9 to 2.5 g/10 min, from 1 to 2.4 g/10 min, from 1.1 to 2.3 g/10 min, from 1.3 to 2.2 g/10 min, or from 1.3 to 2 g/10 min in some aspects, and from 1.4 to 2.2 g/10 min, from 1.4 to 2 g/10 min, from 1.5 to 2.2 g/10 min, or from 1.5 to 2 g/10 min in other aspects.

As determined by ethylene consumption in the first reactor versus total ethylene consumption, the amount of the higher molecular weight (HMW) component in the overall ethylene polymer can vary from 40 to 60 wt. % in one aspect, from 42 to 58 wt. % in another aspect, from 42 to 55 wt. % in another aspect, from 42 to 52 wt. % in yet another aspect, and from 45 to 55 wt. % in still another aspect.

As determined from the density of the overall polymer and the density of the HMW component, the density of the lower molecular weight component (LMW) can be calculated. The calculated density of the LMW component is based on Equation 2: d=wt. %_{HMW}*d_{HMW}+wt. %_{LMW}*d_{LMW} (Eq. 2). In this equation, d is the density of the final polyethylene fluff, wt. %_{HMW} is the weight fraction of the HMW component, d_{HMW} is the density of the HMW component, wt. % LMW is the weight fraction of the LMW component, and d_{LMW} is the density of LMW component. This calculated density of the LMW component is generally very high, typically ranging from 0.96 to 0.975 g/cm³. Other non-limiting ranges for the calculated density of the LMW component include from 0.96 to 0.973 g/cm³, from 0.962 to 0.975 g/cm³, from 0.962 to 0.973 g/cm³, from 0.965 to 0.975 g/cm³, or from 0.965 to 0.973 g/cm³, and the like. As would be readily recognized, the exact polymer properties of the LMW component cannot be measured directly because this LMW component cannot be isolated from the overall bimodal polymer (ethylene polymer).

Likewise, as determined from the HLMI of the overall polymer and the HLMI of the HMW component, the HLMI of the lower molecular weight component (LMW) can be calculated. The calculated HLMI of the LMW component is based on Equation 3: Log(HLMI)=wt. %_{HMW}*Log(HLMI_{HMW})+wt. %_{LMW}*Log(HLMI_{LMW}) (Eq. 3). In this equation, Log (HLMI) is the Log HLMI of the final polyethylene fluff, wt. %_{HMW} is the weight fraction of the HMW component, HLMI_{HMW} is the HLMI of the HMW component, wt. % LMW is the weight fraction of the LMW component, and HLMI_{LMW} is the HLMI of the LMW component. The LMW has a very high (calculated) melt index of generally 800 to 3,000 g/10 min. Other non-limiting ranges for the calculated HLMI of the LMW component include from 800 to 2,500 g/10 min, from 1,000 to 3,000 g/10 min, from 1,000 to 2,800 g/10 min, from 1,000 to 2,500 g/10 min, from 1,200 to 2,600 g/10 min, or from 1,400 to 2,400 g/10 min, and the like.

Ethylene polymers consistent with certain aspects of the invention can have a bimodal molecular weight distribution (as determined using gel permeation chromatography (GPC) or other related analytical technique). Often in a bimodal molecular weight distribution, but not required, there is a valley between the peaks, and the peaks can be separated or deconvoluted. Typically, a bimodal molecular weight distribution can be characterized as having an identifiable high molecular weight component (or distribution) and an identifiable low molecular weight component (or distribution).

Thus, in aspects of this invention, the ethylene polymer can comprise a high or higher molecular weight (HMW) component (or a first component) and a low or lower molecular weight (LMW) component (or a second component). These component terms are relative, are used in reference to each other, and are not limited to the actual molecular weights of the respective components. Unlike the HMW and LMW components determined from the first reactor and calculated for the second reactor, the molecular weight characteristics of LMW and HMW components can be determined by deconvoluting the composite (overall polymer) molecular weight distribution (e.g., determined using gel permeation chromatography). In this context, the Mw (HMW) for these ethylene polymers can range from 200,000 to 500,000 g/mol, from 250,000 to 450,000 g/mol, from 300,000 to 400,000 g/mol, or from 320,000 to 380,000 g/mol, and the like. Additionally or alternatively, the Mn(HMW) for these ethylene polymers can range from 25,000 to 55,000 g/mol, from 30,000 to 50,000 g/mol, from 33,000 to 47,000 g/mol, or from 35,000 to 45,000 g/mol, or from 37,000 to 43,000 g/mol, and the like.

Referring now to the molecular weight distribution of the HMW component, the molecular weight distribution, as quantified by the ratio of Mw/Mn(HMW), is normally in the 6 to 11 range, such as from 6 to 10, from 6 to 9, from 7 to 11, from 7 to 10, from 7 to 9, from 8 to 11, from 8 to 10, or from 8 to 9, and the like.

Referring now to the molecular weight distribution of the LMW component, the molecular weight distribution, as quantified by ratio of Mw/Mn (LMW), is often narrower than that of the HMW component. In one aspect, the lower molecular weight component has a ratio of Mw/Mn from 4 to 8, while in another aspect, the ratio of Mw/Mn is from 4.5 to 7.5 or from 4.5 to 7, and in another aspect, the ratio of Mw/Mw is from 5 to 7.5 or from 5 to 7, and in yet another aspect, the ratio of Mw/Mn is from 5.5 to 7.5 or from 5.5 to 7, and in still another aspect, the ratio of Mw/Mn is from 5.5 to 6.5 or from 5.8 to 6.2.

While not limited thereto, the Mw (LMW) for these ethylene polymers can range from 25,000 to 50,000 g/mol, from 30,000 to 45,000 g/mol, from 30,000 to 40,000 g/mol, from 35,000 to 45,000 g/mol, or from 35,000 to 40,000 g/mol, and the like.

In the context of deconvolution of the MWD, the relative amounts of the LMW and HMW components are not particularly limited, but often the amount of the LMW component, based on the total polymer (HMW plus LMW), falls within a range of from 40 to 60 wt. %. Other typical amounts of the LMW component, based on the total polymer, can range from 40 to 55 wt. %, from 42 to 55 wt. %, from 45 to 55 wt. %, or from 47 to 54 wt. %, and the like.

The ethylene polymers disclosed herein have a beneficial combination of stiffness and strength properties. For instance, the ethylene polymer can be characterized by a yield strength (ASTM D638 Tensile) ranging from 3,000 to 5,000 psi, from 3,300 to 4,700 psi, from 3,500 to 4,500 psi, from 3,500 to 4,200 psi, from 3,700 to 4,500 psi, or from 3,700 to 4,100 psi, and the like. Additionally or alternatively, the ethylene polymer can have an elongation at break (ASTM D638 Tensile) in a range from 700 to 1,000%, from 700 to 950%, from 750 to 950%, from 800 to 1,000%, from 800 to 950%, or from 800 to 900%, and the like. Additionally or alternatively, these ethylene polymers can have a tensile modulus (ASTM D638 Tensile) in a range from 200,000 to 300,000 psi, such as from 200,000 to 280,000 psi, from 220,000 to 300,000 psi, or from 220,000 to 280,000 psi, and the like.

Using ASTM D790 Flexural testing, the ethylene polymers can be characterized by a tangent modulus in a range from 150,000 to 250,000 psi, from 170,000 to 230,000 psi, from 180,000 to 220,000 psi, or from 190,000 to 210,000 psi, and the like. Additionally or alternatively, the ethylene polymer can have a flexural modulus (2% secant modulus) ranging from 100,000 to 180,000 psi. In certain aspects the flex modulus (2% secant modulus) can fall within a range from 125,000 to 175,000 psi; alternatively, from 140,000 to 160,000 psi; or alternatively, from 145,000 to 155,000 psi.

The notched constant ligament stress (NCLS), determined in accordance with ASTM F2136, of the disclosed ethylene polymers is unexpectedly high, particularly surprising given the relatively high polymer densities. In an aspect of this disclosure, these polymers can have NCLS of from 80 to 1,000 hr, and more typically, from 80 to 800 hr or from 100 to 1,000 hr. Other typical ranges include from 100 to 800 hr, from 150 to 1,000 hr, from 150 to 800 hr, or from 150 to 700 hr, and the like. Additionally or alternatively, the ethylene polymers can have a strain hardening modulus (SHM), determined in accordance with ISO 18488, that typically ranges from 20 to 40 MPa, such as from 25 to 40 MPa, from 25 to 38 MPa, from 25 to 35 MPa, from 28 to 40 MPa, from 28 to 35 MPa, from 30 to 40 MPa, from 30 to 38 MPa, or from 30 to 35 MPa, and the like

Additionally or alternatively, the full-notch creep test (FNCT), determined in accordance with ISO 16770 (using Arkopal N 100, 2% aqueous solution, as the test liquid), of the disclosed ethylene polymers also is unexpectedly high. Independently, the test temperature can be any one of 50, 60, 80, or 90° C., and the test force or pressure can be any one of 2, 4, 6, 8, 9, or 12 MPa (for example, a test temperature of 50° C. and a test force or pressure of 9 MPa, or a test temperature of 80° C. and a test force or pressure of 6 MPa). At any of these test conditions, these ethylene polymers can have a FNCT value of at least 100 hr, and more typically, at least 200 hr, at least 500 hr, at least 1000 hr, at least 5,000 hr, at least 10,000 hr, or at least 25,000 hr. The FNCT test is typically stopped after a certain number of hours is reached, and given the long duration of the test, the upper limit of FNCT (in hr) is generally not determined.

For certain end-use applications, it can be beneficial to have a high heat deflection temperature (HDT), such as at least 60° C. or at least 70° C., measured in accordance with ASTM D648. HDT quantifies a polymer's ability to remain rigid or “stiff” under a constant load and at elevated temperatures. Thus, it indicates at what temperature a polymer starts to “soften” under a fixed load. While not limited thereto, the HDT of the disclosed ethylene polymers can range from 60 to 90° C., such as from 60 to 85° C., from 65 to 90° C., from 65 to 85° C., from 70 to 90° C., or from 70 to 85° C., and the like. Similarly, it can be beneficial to have a high thermal stability, such as at least 240° C. or at least 250° C., measured in accordance with ASTM D3350. While not limited thereto, the thermal stability of the disclosed ethylene polymers can range from 240 to 270° C., such as from 240 to 260° C., from 240 to 255° C., from 245 to 265° C., from 245 to 255° C., or from 250 to 255° C., and the like. Another indicator of the thermal stability and resistance to oxidative decomposition is the Oxidative-Induction Time (OIT), measured in accordance with ASTM D3895. While not limited thereto, the OIT of the disclosed ethylene polymers can range from 50 to 90 min, such as from 50 to 75 min, from 55 to 85 min, from 55 to 75 min, or from 55 to 70 min, and the like.

A particular beneficial combination of properties of the ethylene polymer includes the main properties noted above (a melt index from 0.15 to 0.5 g/10 min, a high load melt index from 15 to 50 g/10 min, a density from 0.94 to 0.96 g/cm³, a HMW HL275 from 3 to 8 g/10 min, and a HMW density from 0.92 to 0.94 g/cm³) in combination with the ESCR of at least 1,000 hr (or at least 2,800 hr, or any other range disclosed herein), or in combination with the yield strength of 3,000 to 5,000 psi (or from 3,700 to 4,500 psi, or any other range disclosed herein), or in combination with the viscosity at 100 sec⁻¹ of 1,000 to 1,800 Pa-sec (or from 1,200 to 1,600 Pa-sec, or any other range disclosed herein), or in combination with the NCLS of 80 to 1,000 hr (or from 150 to 800 hr, or any other range disclosed herein), or in combination with any two or more of the ESCR, yield strength, viscosity at 100 sec⁻¹, and/or NCLS properties disclosed herein.

Moreover, these ethylene polymers can be produced with Ziegler-Natta catalyst systems containing magnesium and titanium, discussed further below. Metallocene and chromium based catalysts systems are not required. Therefore, the ethylene polymer can contain no measurable amount of Hf, Zr, and/or Cr (catalyst residue), i.e., less than 0.1 ppm by weight. In some aspects, the ethylene polymer can contain less than 0.08 ppm, less than 0.05 ppm, or less than 0.03 ppm, independently, of Hf, Zr, and/or Cr.

Due to the excellent ESCR and mechanical properties (e.g., yield strength), it is expected that post-consumer recycle (PCR) and/or post-industrial recycle (PIR) can be combined with the ethylene polymer with no significant adverse impact on the properties and processability (e.g., within +/−10%, or within +/−5%). Thus, a polymer composition contemplated herein can comprise the ethylene polymer and from 2 to 50 wt. %, from 2 to 20 wt. %, from 5 to 40 wt. %, from 5 to 25 wt. %, from 5 to 15 wt. %, or from 10 to 30 wt. % of any suitable post-consumer recycle (PCR) and/or post-industrial recycle (PIR) resin(s). Often, PIR is present in the polymer composition at amounts up to and including 40 wt. %, and PCR is present in the polymer composition at amounts up to and including 30 wt. %.

### Articles and Products

Articles of manufacture can be formed from, and/or can comprise, the ethylene polymers (or polymer compositions) of this invention and, accordingly, are encompassed herein. For example, articles which can comprise the polymers (or compositions) of this invention can include, but are not limited to, an agricultural film, an automobile part, a bottle, a container for chemicals, a drum, a dunnage bag, a fiber or fabric, a food packaging film or container, a food service article, a fuel tank, a geomembrane, a household container, a liner, a molded product, a medical device or material, an outdoor storage product, outdoor play equipment, a pipe, a sheet or tape, a toy, or a traffic barrier, and the like. Various processes can be employed to form these articles. Non-limiting examples of these processes include injection molding, blow molding, rotational molding, film extrusion, sheet extrusion, profile extrusion, thermoforming, and the like.

Additionally, additives and modifiers often are added to these polymers (or compositions) in order to provide beneficial polymer processing or end-use product attributes. Suitable additives that can be employed in the polymers (or compositions) and resultant articles of manufacture can include, but are not limited to, an antioxidant, an acid scavenger, an antiblock additive, a slip additive, a colorant (e.g., carbon black), a filler, a polymer processing aid, a UV inhibitor (e.g., a light stabilizer), and the like, and this includes any combination of two or more of these additives in any suitable loading/amount. Such processes and materials are described in Modern Plastics Encyclopedia, Mid-November 1995 Issue, Vol. 72, No. 12; and Film Extrusion Manual—Process, Materials, Properties, TAPPI Press, 1992. In some aspects of this invention, an article of manufacture can comprise any of the ethylene polymers (or compositions) described herein, and the article of manufacture can be or can comprise a wire, a cable, or a conduit pipe. The cable can be a power cable, inclusive of low voltage, medium voltage, and high voltage power cables. In other aspects, an article of manufacture can comprise any of the ethylene polymers (or compositions) described herein, and the article of manufacture can be or can comprise a blow molded product, inclusive of bottles and other containers for household industrial chemicals and the like.

Depending upon the end-use of the ethylene polymer (or composition) or the article formed therefrom, it can be beneficial to have a lower static and/or kinetic coefficient of friction (COF). The COF is an indicator of the ability of the material to slide against itself or another surface, and the higher the COF, the less likely it will be to slip or move (tackier). In a conduit application, for instance, a lower COF translates to easier installation. Generally, the ethylene polymer (or composition) and/or the article formed therefrom can have a kinetic COF of less than or equal to 0.5, less than or equal to 0.4, less than or equal to 0.3, less than or equal to 0.2, or less than or equal to 0.1, with illustrative ranges including form 0.05 to 0.3, from 0.05 to 0.2, from 0.1 to 0.3, or from 0.1 to 0.2. The COF can be determined in accordance with ASTM D1894.

### Catalysts and Polymerization Processes

In accordance with aspects of the present invention, the ethylene polymer can be produced using a Ziegler-Natta catalyst system in a dual reactor polymerization reactor system. Ziegler-Natta catalyst systems are well known to those skilled in the art and any suitable Ziegler-Natta catalyst system can be used herein. The same or a different Ziegler-Natta catalyst system can be used in each reactor of the dual reactor polymerization reactor system.

The HMW component and the LMW component, as described hereinabove, are produced in different reactors. Any suitable reactors can be used in the dual reactor system, such as one or two slurry reactors, one or two gas-phase reactors, one or two solution reactors, or a combination of two different reactor types, and operated in series or parallel. In a particular aspect, the reactor system contains two slurry reactors, such as two loop slurry reactors operating in series. While not limited thereto, often the HMW component is produced in the first loop slurry reactor, while the LMW component and subsequently the final polymer are produced in the second loop slurry reactor.

After production of the HMW component in the first reactor, the polymerization reactor system can be configured with a transfer device or transfer line for transferring the contents of the first reactor into the second reactor. The polymerization reaction conditions in first reactor can be different from that of the second reactor.

When the polymerization reactor system contains at least one loop slurry reactor, the loop slurry reactor can have vertical or horizontal loops. Monomer, diluent, catalyst, and comonomer can be continuously fed to the loop reactor where polymerization occurs. Generally, continuous loop slurry processes can comprise the continuous introduction of monomer/comonomer, a catalyst, and a diluent into the reactor and the continuous removal from this reactor of a suspension comprising polymer particles and the diluent. Reactor effluent can be flashed to remove the solid polymer from the liquids that comprise the diluent, monomer and/or comonomer. Various technologies can be used for this separation step including, but not limited to, flashing that can include any combination of heat addition and pressure reduction, separation by cyclonic action in either a cyclone or hydrocyclone, or separation by centrifugation. Typical slurry polymerization process (also known as the particle form process) are disclosed, for example, in U.S. Pat. Nos. 3,248,179, 4,501,885, 5,565,175, 5,575,979, 6,239,235, 6,262,191, 6,833,415, and 8,822,608. Suitable diluents used in slurry polymerization include, but are not limited to, the monomer being polymerized and hydrocarbons that are liquids under reaction conditions. Examples of suitable diluents include, but are not limited to, hydrocarbons such as propane, cyclohexane, isobutane, n-butane, n-pentane, isopentane, neopentane, and n-hexane. Some loop polymerization reactions can occur under bulk conditions where no diluent is used.

Polymerization conditions that can be controlled for efficiency and to provide desired polymer properties can include temperature, pressure, and the concentrations of various reactants. Polymerization temperature can affect catalyst productivity, polymer molecular weight, and molecular weight distribution. Various polymerization conditions can be held substantially constant, for example, for the production of a particular grade of the ethylene polymer. A suitable polymerization temperature can be any temperature below the de-polymerization temperature according to the Gibbs Free energy equation. Typically, this includes from 60° C. to 280° C., for example, or from 60° C. to 120° C., depending upon the type of polymerization reactor(s). In some reactor systems with loop slurry reactors, the polymerization temperature generally can be within a range from 70° C. to 105° C., or from 75° C. to 100° C.

Suitable pressures will also vary according to the reactor and polymerization type. The pressure for liquid phase polymerizations in a loop reactor is typically less than 1000 psi (6.9 MPa). Pressure for gas phase polymerization is usually from 200 to 500 psi (1.4 MPa to 3.4 MPa). High pressure polymerization in tubular or autoclave reactors is generally run at from 20,000 to 75,000 psi (138 to 517 MPa). Polymerization reactors can also be operated in a supercritical region occurring at generally higher temperatures and pressures. Operation above the critical point of a pressure/temperature diagram (supercritical phase) can offer advantages to the polymerization reaction process.

Consistent with aspects of this invention, the process for producing the ethylene polymer can comprise a first step of introducing ethylene, a hydrocarbon diluent, a Ziegler-Natta catalyst system, optionally hydrogen, and optionally an olefin comonomer into the first loop slurry reactor, then forming the HMW component of the ethylene polymer in the first loop slurry reactor. The HMW component can be transferred to the second loop slurry reactor where ethylene, optionally hydrogen, and optionally an olefin comonomer are polymerized in the presence of the HMW component to produce the LMW component and subsequently the bimodal ethylene polymer.

The polymerization reactor system can further comprise any combination of at least one raw material feed system, at least one feed system for catalyst or catalyst components, and/or at least one polymer recovery system. Suitable reactor systems can further comprise systems for feedstock purification, catalyst storage and preparation, extrusion, reactor cooling, polymer recovery, fractionation, recycle, storage, loadout, laboratory analysis, and process control. Depending upon the desired properties of the olefin polymer, hydrogen can be added to each polymerization reactor as needed (e.g., continuously or pulsed).

When a copolymer is desired, ethylene can be copolymerized with a comonomer (e.g., a C₂-C₂₀ alpha-olefin or a C₃-C₂₀ alpha-olefin). According to one aspect of this invention, the comonomer can comprise a C₃-C₁₀ alpha-olefin; alternatively, the comonomer can comprise 1-butene, 1-pentene, 1-hexene, 1-octene, 1-decene, styrene, or any combination thereof; alternatively, the comonomer can comprise 1-butene, 1-hexene, 1-octene, or any combination thereof; alternatively, the comonomer can comprise 1-butene; alternatively, the comonomer can comprise 1-hexene; or alternatively, the comonomer can comprise 1-octene.

### EXAMPLES

The invention is further illustrated by the following examples, which are not to be construed in any way as imposing limitations to the scope of this invention. Various other aspects, modifications, and equivalents thereof which, after reading the description herein, can suggest themselves to one of ordinary skill in the art without departing from the spirit of the present invention or the scope of the appended claims.

Melt index (MI, g/10 min) was determined in accordance with ASTM D1238 at 190° C. with a 2.16 kg weight, I₅ was determined in accordance with ASTM D1238 at 190° C. with a 5 kg weight, and high load melt index (HLMI, g/10 min) was determined in accordance with ASTM D1238 at 190° C. with a 21.6 kg weight. HL275 was determined in accordance with ASTM D1238 at 190° C. with a 21.6 kg weight, similar to HLMI, except that a die with a 2.75 mm diameter orifice was used, as described in U.S. Pat. No. 10,053,563.

Density was determined in grams per cubic centimeter (g/cm³) on a compression molded sample, cooled at 15° C. per minute, and conditioned for 40 hours at room temperature in accordance with ASTM D1505 and ASTM D4703.

Environmental stress crack resistance (ESCR) was determined in accordance with ASTM D1693, condition B, with 10% Igepal. The measured time to failure (hr) is the result of the ESCR test.

Molecular weights and molecular weight distributions were obtained using a PL-GPC 220 (Polymer Labs, an Agilent Company) system equipped with a IR4 detector (Polymer Char, Spain) and three Styragel HMW-6E GPC columns (Waters, MA) running at 145° C. The flow rate of the mobile phase 1,2,4-trichlorobenzene (TCB) containing 0.5 g/L 2,6-di-t-butyl-4-methylphenol (BHT) was set at 1 mL/min, and polymer solution concentrations were in the range of 1.0-1.5 mg/mL, depending on the molecular weight. Sample preparation was conducted at 150° C. for nominally 4 hr with occasional and gentle agitation, before the solutions were transferred to sample vials for injection. An injection volume of about 400 μL was used. The integral calibration method was used to deduce molecular weights and molecular weight distributions using a Chevron Phillips Chemical Company's HDPE polyethylene resin, MARLEX® BHB5003, as the broad standard. An integral table of the broad standard was pre-determined in a separate experiment with SEC-MALS. Mn is the number-average molecular weight, Mw is the weight-average molecular weight, Mz is the z-average molecular weight, Mv is the viscosity-average molecular weight, and Mp is the peak molecular weight (location, in molecular weight, of the highest point of the molecular weight distribution curve). The IB parameter was determined from the molecular weight distribution curve (plot of dW/d(Log M) vs. Log M; normalized to an area equal to 1), and is defined as 1/[dW/d(Log M)]_{MAX}. IVc is the intrinsic viscosity [η], which is calculated based on Equation 4: [η]=K Mv^{a} (Eq. 4).

In Equation 4, Mv is the viscosity-average molecular weight, K and a are Mark-Houwink constants for the polymer of interest. For polyethylene, K and a are 3.95E-04 (dL/g) and 0.726 (unitless), respectively. Mv is calculated based on Equation 5, where wᵢ and Mᵢ are weight fraction and molecular weight of slice i, respectively:

M_{V}=[ΣwᵢMᵢ^{a}/Σwᵢ]^{1/a} (Eq. 5).

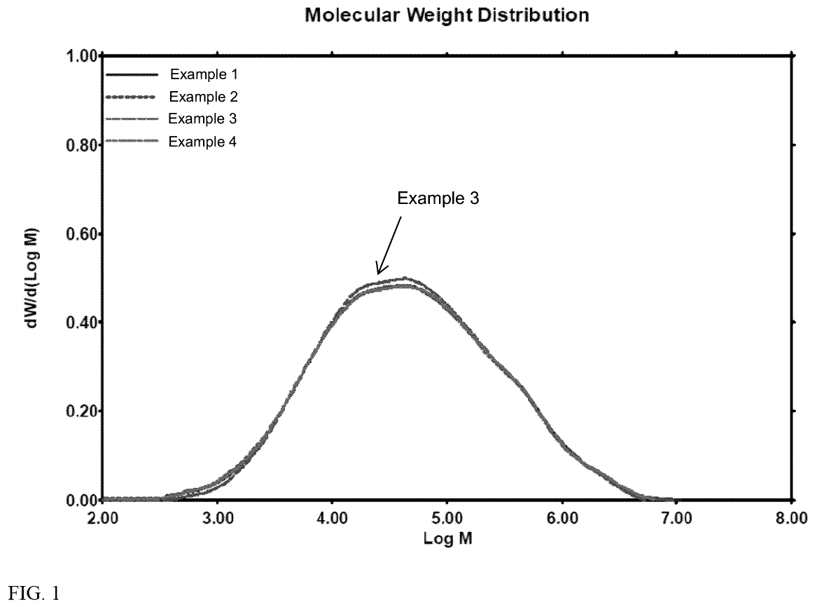

The respective LMW component and HMW component properties were determined by deconvoluting the molecular weight distribution (see FIG. 1) of each polymer. The relative amounts of the LMW and HMW components (weight percentages) in the polymer were determined using an Excel based spreadsheet program fitting 5 Shultz-Flory Distributions (SFDs) to each component (5 for the LMW and 5 for the HMW). The LMW and HMW could then be fractioned to fit the overall MWD, providing the deconvolution. Properties for the each of the LMW and HMW components were then calculated.

Melt rheological characterizations were performed as follows. Small-strain (less than 10%) oscillatory shear measurements were performed on an Anton Paar MCR rheometer using parallel-plate geometry. All rheological tests were performed at 190° C. The complex viscosity |η*| versus frequency (ω) data were then curve fitted using the modified three parameter Carreau-Yasuda (CY) empirical model to obtain the zero shear viscosity—η₀, characteristic viscous relaxation time—τ_{η}, and the breadth parameter—a (CY-a parameter). The simplified Carreau-Yasuda (CY) empirical model is shown in Equation 6:

$$\vert {η}^{*} ( ω ) \vert = \frac{{η}_{0}}{{[ 1 + {( {τ}_{η} ω )}^{a} ]}^{( 1 - n ) / a}} , \qquad ( Eq . 6 )$$

wherein:
   |η*(ω)|=magnitude of complex shear viscosity;
η₀=zero shear viscosity;
τ_{η}=viscous relaxation time (Tau(n));
a=“breadth” parameter (CY-a parameter);
n=fixes the final power law slope, fixed at 2/11; and
ω=angular frequency of oscillatory shearing deformation.

Details of the significance and interpretation of the CY model and derived parameters can be found in: C. A. Hieber and H. H. Chiang, Rheol. Acta, 28, 321 (1989); C. A. Hieber and H. H. Chiang, Polym. Eng. Sci., 32, 931 (1992); and R. B. Bird, R. C. Armstrong and O. Hasseger, Dynamics of Polymeric Liquids, Volume 1, Fluid Mechanics, 2nd Edition, John Wiley & Sons (1987). The tan δ at 0.1 sec⁻¹, tan δ at 100 sec⁻¹, viscosity at 0.1 sec⁻¹, viscosity at 100 sec⁻¹, and viscosity at HLMI (viscosity at the HLMI stress for the polymer at its HLMI) properties were determined using the Carreau-Yasuda (CY) empirical model.

Tensile properties, such as yield strength, elongation at break, and tensile modulus were determined in accordance with ASTM D638 at 23° C. Tangent modulus and flexural modulus (1% secant and 2% secant) were determined in accordance with ASTM D790 at 23° C. Notched Constant Ligament Stress (NCLS) was determined in accordance with ASTM F2136 at a stress of 4.125 MPa (600 psi). The measured time to failure (hr) is the result of the NCLS test. Strain Hardening Modulus (SHM) was determined in accordance with ISO 18488. Heat deflection temperature (HDT) was determined in accordance with ASTM D648 (at 66 psi).

Metals content, such as the amount of catalyst residue in the ethylene polymer or article, can be determined by ICP analysis on a PerkinElmer Optima 8300 instrument. Polymer samples can be ashed in a Thermolyne furnace with sulfuric acid overnight, followed by acid digestion in a HotBlock with HCl and HNO3 (3:1 v:v).

### Examples 1-4, C5-C6, and 7-10

Comparative Example 5 (C5) was a commercially available unimodal resin from Chevron Phillips Chemical Company LP. Comparative Example 6 (C6) was a commercially available bimodal resin from The Dow Chemical Company. Inventive Examples 1-4 were prepared in a large scale dual loop slurry reactor system at a nominal reactor pressure of 650 psi, and the polymerization conditions in the first reactor (R×A) and the second reactor (R×B) are summarized in Table A. Residence times in R×A and R×B independently ranged from 30-90 min, and from 45-75 min in most cases. Typically, the residence times in each reactor were about the same (e.g., within +/−10%). The solid Ziegler-Natta catalyst had a d50 average particle size of 4-8 microns and a particle size span ((d90−d10)/d50) of approximately 1.5. The catalyst nominally contained 5.5-9.5 wt. % titanium (e.g., in the form of TiCl₄ and/or TiCl₃) and 10-15 wt. % magnesium (e.g., in the form of a MgCl₂ support). Optionally, the catalyst can contain an internal donor.

Tables 1-8 summarize the polymer properties of Examples 1-4 and, where appropriate, Comparative Examples C5-C6. As shown in Table 3, the ESCR performance of the polymers of Examples 1 and 3 was superior, by at least an order of magnitude, over the polymer of Comparative Example C5. It was expected that Examples 2 and 4, if tested, would have similar ESCR performance to that of Examples 1 and 3 (in excess of 3,000 hr).

The polymers of Examples 1-4 had melt indices of 0.3-0.4 g/10 min, high load melt indices of 25-40 g/10 min, densities of 0.950-0.955 g/cm³, HMW HL275 values of 4.9-6 g/10 min, and HMW densities of 0.93-0.935 g/cm³, as reflected in Tables 1-3. FIG. 1 illustrates the molecular weight distributions (amount of polymer versus the logarithm of molecular weight) of the polymers of Examples 1-4, while Table 4 summarizes the molecular weight characterization. Tables 5-6 summarize the deconvoluted molecular weight data and respective molecular weight parameters for the LMW and HMW components of the polymers of Examples 1-4.

Rheological properties are summarized in Tables 7-8 for the polymers of Examples 1-4 and Comparative Examples C5-C6. As compared to C5, the polymers of Examples 1-4 had much lower zero-shear viscosity and relaxation time, and much higher values for the CY-a parameter and tan d@0.1 sec⁻¹. As compared to C₆, the polymers of Examples 1-4 had lower relaxation time, CY-a parameter, and tan d@0.1 sec⁻¹, higher tan d @100 sec⁻¹, and much lower viscosity at 100 sec⁻¹.

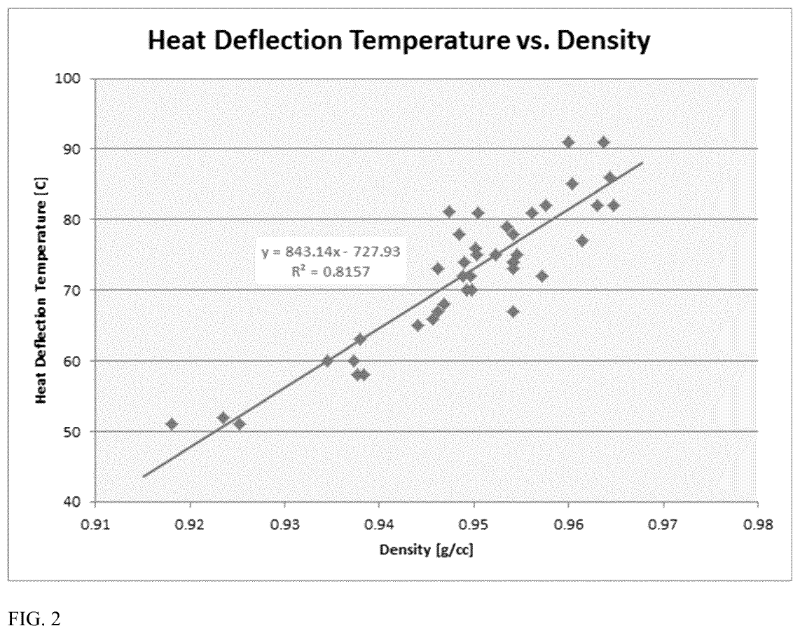

Tensile, Flex, NCLS, SHM, and HDT properties are summarized in Tables 9-10, and FIG. 2 illustrates the relationship between HDT and polymer density for a variety of ethylene polymers having densities in the 0.91-0.97 g/cm³ range. In Tables 9-10, Examples 7-10 are test values for inventive ethylene polymers that encompass and are representative of Examples 1-4, but the specific ethylene polymers of Examples 1-4 were not tested for the physical properties in Tables 9-10. Of particular note, Examples 7-10 had much higher yield strength, tensile modulus, and NCLS than that of Comparative Examples C5-C6.

TABLE A
Polymerization Conditions

| | Example 1 | | Example 2 | | Example 3 | | Example 4 | |
|---|---|---|---|---|---|---|---|---|
| | RxA | RxB | RxA | RxB | RxA | RxB | RxA | RxB |
| Temperature | 188 | 202 | 188 | 202 | 188 | 202 | 188 | 202 |
| (° F.) | | | | | | | | |
| H₂/C₂ Feed | 0.035 | — | 0.035 | — | 0.038 | — | 0.038 | — |
| (lb/Mlb) | | | | | | | | |
| H₂/C₂ Ratio | — | 0.29 | — | 0.29 | — | 0.29 | — | 0.29 |
| (molar) | | | | | | | | |
| C₆/C₂ Feed | 55 | — | 55 | — | 55 | — | 55 | — |
| (lb/Mlb) | | | | | | | | |
| Triethylaluminum | 50 | 50 | 50 | 50 | 50 | 50 | 50 | 50 |
| (ppm) | | | | | | | | |
| C₂ = Concentration | — | 2 | — | 2 | — | 2 | — | 2 |
| (wt. %) | | | | | | | | |
| Solids | 46.5 | 45 | 46.5 | 45 | 46.5 | 45 | 46.5 | 45 |
| (wt. %) | | | | | | | | |
| RxB/RxA C₂ Feed | — | 1.1 | — | 1.1 | — | 1.1 | — | 1.1 |
| Ratio (lb/lb) | | | | | | | | |

TABLE 1
Polymer Pellet Properties

| | MI | HLMI | HLMI/ | Density | I₅ |
|---|---|---|---|---|---|
| Example | (g/10 min) | (g/10 min) | MI | (g/cc) | (g/10 min) |
| 1 | 0.308-0.322 | 35.3-34.5 | 106-112 | 0.950-0.951 | 1.79 |
| 2 | 0.340-0.355 | 35.7-37.6 | 102-109 | 0.951 | — |
| 3 | 0.355 | 38.6 | 108-109 | 0.951 | — |
| 4 | 0.317-0.364 | 27.9-36.7 | 98-103 | 0.951-0.953 | — |
| C5 | 0.3 | 35 | 115 | 0.947 | — |
| C6 | 0.28 | 27 | 96 | 0.954 | — |

TABLE 2
HMW Component Reactor A Properties

| | Fluff A | Fluff A | | |
|---|---|---|---|---|
| | HL275 | HLMI | Fluff A | A |
| | (g/10 | calculated | Density | wt. % |
| Example | min) | (g/10 min) | (g/cc) | polymer |
| 1 | 4.92-5.22 | 1.54-1.63 | 0.930-0.931 | 49.5 |
| 2 | 4.92-5.25 | 1.54-1.64 | 0.930 | 49.5 |
| 3 | 5.25-5.51 | 1.64-1.72 | 0.930-0.931 | 49.5 |
| 4 | 4.98-5.92 | 1.56-1.85 | 0.931-0.933 | 49.5 |

TABLE 3
LMW Component Reactor B Properties

| | Fluff | Fluff B | Fluff B | | |
|---|---|---|---|---|---|
| | Final | HLMI | Density | B | ESCR, |
| | (g/10 | calculated | calculated | wt. % | Cond B, |
| Example | min) | (g/10 min) | (g/cc) | polymer | 10% (hr) |
| 1 | 53.0-62.1 | 1,600-2,200 | 0.969-0.972 | 50.5 | >3,500 |
| 2 | 53.0-56.3 | 1,600-1,800 | 0.971-0.972 | 50.5 | — |
| 3 | 56.3-58.0 | 1,800-1,900 | 0.971-0.972 | 50.5 | >3,000 |
| 4 | 58.0-63.8 | 1,800-2,200 | 0.970-0.972 | 50.5 | — |
| C5 | — | — | — | — | 290 |
| C6 | — | — | — | — | — |

TABLE 4
Molecular Weight Characterization (molecular weights in kg/mol)

| Example | Mn | Mw | Mz | Mp | Mw/Mn | Mz/Mw | IB | IVc |
|---|---|---|---|---|---|---|---|---|
| 1 | 11.6 | 203.8 | 1,544.7 | 39.0 | 17.65 | 7.58 | 2.07 | 7.23 |
| 2 | 11.3 | 199.1 | 1,443.2 | 40.6 | 17.67 | 7.25 | 2.07 | 6.94 |
| 3 | 13.1 | 182.4 | 1,081.0 | 42.9 | 13.90 | 5.93 | 2.00 | 5.72 |
| 4 | 11.5 | 196.0 | 1,269.8 | 42.9 | 17.12 | 6.48 | 2.07 | 6.40 |
| C5 | 8.2 | 128.7 | 541.3 | 63.8 | 15.67 | 4.20 | 1.83 | 3.49 |
| C6 | 10.0 | 184.0 | 947.9 | 20.3 | 18.38 | 5.15 | 2.14 | 5.20 |

TABLE 5
Molecular Weight Characterization (kg/mol) - LMW component

| | | | | | | LMW |
|---|---|---|---|---|---|---|
| Example | Mn | Mw | Mz | Mw/Mn | Mz/Mw | Fraction |
| 1 | 6.2 | 36.8 | 131.5 | 5.98 | 3.57 | 0.505 |
| 2 | 6.0 | 36.1 | 128.9 | 5.97 | 3.57 | 0.508 |
| 3 | 6.4 | 38.6 | 137.7 | 6.00 | 3.56 | 0.520 |
| 4 | 6.1 | 36.8 | 131.4 | 5.98 | 3.57 | 0.505 |

TABLE 6
Molecular Weight Characterization (kg/mol) - HMW component

| | | | | | | HMW |
|---|---|---|---|---|---|---|
| Example | Mn | Mw | Mz | Mw/Mn | Mz/Mw | Fraction |
| 1 | 40.4 | 348.7 | 1,279.7 | 8.64 | 3.67 | 0.495 |
| 2 | 39.9 | 344.8 | 1,265.5 | 8.64 | 3.67 | 0.492 |
| 3 | 40.3 | 348.6 | 1,279.8 | 8.64 | 3.66 | 0.480 |
| 4 | 40.4 | 348.7 | 1,279.7 | 8.64 | 3.67 | 0.495 |

TABLE 7
Rheological Properties at 190° C.

| | Zero shear | Tau(η) | CY-a | Tan d @ 0.1 | Tan d @ 100 |
|---|---|---|---|---|---|
| Example | (Pa-sec) | (sec) | parameter | (degrees) | (degrees) |
| 1 | 78,760 | 0.424 | 0.266 | 2.45 | 0.733 |
| 2 | 73,040 | 0.384 | 0.266 | 2.50 | 0.742 |
| 3 | 72,320 | 0.380 | 0.267 | 2.52 | 0.742 |
| 4 | 84,390 | 0.437 | 0.265 | 2.43 | 0.731 |
| C5 | 878,800 | 4.195 | 0.156 | 1.47 | 0.753 |
| C6 | 80,360 | 0.560 | 0.343 | 2.75 | 0.605 |

TABLE 8
Rheological Properties at 190° C.

| | η @ 0.1 | η @ 100 | η @ HLMI | η @ 0.1/ |
|---|---|---|---|---|
| Example | (Pa-sec) | (Pa-sec) | (Pa-sec) | η @ 100 |
| 1 | 26,100 | 1,396 | 803 | 18.70 |
| 2 | 24,890 | 1,378 | 782 | 18.06 |
| 3 | 24,880 | 1,381 | 786 | 18.02 |
| 4 | 27,580 | 1,460 | 905 | 18.89 |
| C5 | 32,900 | 1,124 | 472 | 29.27 |
| C6 | 37,710 | 1,745 | 1,375 | 21.61 |

TABLE 9
Physical Properties

| | Yield | Elongation | Tensile | Tangent |
|---|---|---|---|---|
| | Strength | @ Break | Modulus | Modulus |
| Example | (psi) | (%) | (psi) | (psi) |
| 7 | 3,890 | 860 | 240,000 | 200,400 |
| 8 | 3,810 | 855 | 238,600 | 197,400 |
| 9 | 3,820 | 849 | 232.400 | 197,600 |
| 10 | 3,880 | 831 | 261,400 | 201,800 |
| C5 | 3,250 | 488 | 189,800 | 148,600 |
| C6 | 3,300 | 750 | — | — |

TABLE 10
Physical Properties

| | | | Notched | | |
|---|---|---|---|---|---|
| | Flexural | Flexural | Constant | Strain | Heat |
| | Modulus | Modulus | Ligament | Hardening | Deflection |
| | 2% Secant | 1% Secant | Stress | Modulus | Temperature |
| Example | (psi) | (psi) | (hr) | (MPa) | (° C.) |
| 7 | 151,800 | 180,000 | 83 | 34.9 | 71.9 |
| 8 | 148,600 | 177,000 | 343 | 33.4 | 73.5 |
| 9 | 148,800 | 176,400 | 172 | 32.9 | — |
| 10 | 149,800 | 178,400 | 686 | 33.9 | — |
| C5 | 110,200 | 130,400 | 47 | — | — |
| C6 | 145,000 | — | — | — | — |

### Example 11

For an initial processability comparison, a sample of the inventive ethylene polymer representative of Examples 1-4 and a sample of Comparative Example C5 were extruded on a Krauss Maffei laboratory scale extrusion line (45 mm, 36:1 L/D grooved feed) to produce 2″ DR11 pipe (pressure rating of 160 psi, dimension ratio (DR) of 11, which is the ratio of the average outside diameter of the pipe to its minimum wall thickness), as summarized in the Table 11 below. In sum, the inventive bimodal polymer demonstrated excellent processing and performance properties with only minor deviations from standard unimodal conduit resin of Comparative Example C5.

TABLE 11
Extrusion Summary of Example 11

| | Comparative | Inventive |
|---|---|---|
| | Example C5 | Bimodal Polymer |
| | 2″ DR11 | 2″ DR11 |
| Melt index (g/10 min) | 0.32 | 0.36 |
| HLMI (g/10 min) | 32 | 36 |
| Screw Speed (rpm) | 256 | 257 |
| Haul-Off Speed (ft/min) | 14.29 | 14.29 |
| Melt Throughput (lb/hr) | 500 | 500 |
| Melt Pressure (psi) | 2434 | 2556 |
| Melt Temperature (° F.) | 402 | 405 |
| Screw Torque (%) | 58 | 63 |
| Specific Energy (kW-hr/lb) | 0.07 | 0.08 |
| Specific Output (pph/rpm) | 1.94 | 1.95 |

### Examples 12-15

The inventive bimodal ethylene polymer also was evaluated on several large scale manufacturing lines, including 165 mm, 100 mm, 75 mm, and 65 mm extruders, with both smooth-bore and grooved-feed designs. IPS schedule 40 conduit pipe was produced in 1.25″, 1.685″ and 4.0″ diameters. These experiments were initiated using unimodal Comparative Examples C5 to produce acceptable pipe before transitioning to the inventive bimodal ethylene polymer (representative of Examples 1-4) while monitoring processing conditions and making any needed adjustments to maintain production of acceptable pipe. In addition, in-plant regrind content, varying from 30-50 wt. %, was used in one 4.0″ diameter conduit pipe experiment.

For Example 12, the resins were compounded in-line with a carbon black masterbatch and fed into a 100 mm, 30:1 L/D, smooth-bore extruder. When compared to a higher L/D, the 30:1 L/D is a greater challenge for mixing. Throughput on a smooth-bore, compared to groove-feed, is highly dependent up on rheology (e.g., MI, HLMI, viscosity). Prior to transitioning from the unimodal Comparative Examples C5 polymer, extruder parameters (e.g., 24 ft/min haul-off) and pipe dimensions (2″ black pipe) were taken to provide a baseline. Once the inventive bimodal polymer was fully transitioned, data showed the extruder pressure increased by only about 7-10%. Wall thickness values were maintained with no change in puller speed and pipe production rate. Once the pipe dimensions, exterior and interior surfaces, and puller speed were verified to be acceptable, pipe samples were collected, and cold impact testing was performed with all samples passing this test.

For Example 13, the resins were compounded in-line with a carbon black masterbatch and fed into a 165 mm grooved-fed extruder with 30-50 wt. % in-house unimodal regrind to produce 4.0″ IPS Schedule 40 conduit pipe (black). As compared to unimodal C5, the extrusion line produced conduit pipe from the inventive bimodal ethylene polymer with stable operating conditions and dimensions within specifications with minimal adjustments. The melt temperature was 436° F. and the haul-off speed was 62 ft/min. Unexpectedly, the die pressure was lower while using the inventive polymer, as compared to the unimodal C5 polymer, and ultimately the inventive polymer continued to run for approximately 20 hr, demonstrating a potential 15% increase in throughput rate or line speed due to the lower die pressure.

For Example 14, the resins were compounded in-line with a carbon black masterbatch and fed into a 65 mm grooved-feed extruder to produce 1.25″ IPS Schedule 40 conduit pipe (black). While holding the screw speed constant, the process responses in melt temperature, melt pressure, screw torque and haul-off speed were monitored. As shown in Table 12 below, screw torque and melt pressure increased slightly, while the melt temperature and haul-off speed were unaffected. Pipe dimensions were measured and easily adjusted to maintain standard tolerances for pipe dimensions. Pipe wall thickness values were maintained with no change in puller speed or pipe production rate.

For Example 15, the resins were fed into a 75 mm smooth-bore extruder to produce 1.25″ IPS Schedule 40 conduit pipe. After transitioning from the unimodal C5 conduit resin to (100% virgin) inventive ethylene polymer, the focus again was to maintain a constant screw speed and monitor changes in melt temperature, motor load, and haul-off speed. With the screw speed remaining constant, the melt temperature increased just slightly while the motor load increased just over 8%. Haul-off speed stayed approximately the same without any adjustments. There were no challenges to maintain consistent production speed while extruding the inventive ethylene polymer. Pipe dimensions were measured and the process parameters were easily adjusted to maintain standard tolerances. Pipe wall thickness values were maintained with no change in puller speed or pipe production rate. Table 13 provides a summary of Example 15.

In sum, these examples indicate that the unimodal comparative example C₅ resin can be replaced with the inventive bimodal polymer with equivalent pipe dimension tolerances, puller feet-per-minute output, and overall processability, yet with a significant improvement in ESCR performance, as shown in Table 3 above.

TABLE 12
Extrusion Summary of Example 14

| | Unimodal | Inventive ethylene polymer | |
|---|---|---|---|
| | C5 | (no adjustments) | |
| Screw Speed (rpm) | 176.3 | 177.0 | No change |
| Screw Torque (%) | 88 | 94 | +6.8% |
| Melt Temperature (° F.) | 373 | 374 | No change |
| Melt Pressure (psi) | 3,474 | 3,849 | +10.8% |
| Haul-Off Speed (ft/min) | 45.8 | 45.8 | No change |

TABLE 13
Extrusion Summary of Example 15

| | | Inventive ethylene polymer | |
|---|---|---|---|
| | Unimodal C5 | (no adjustments) | |
| Screw Speed (rpm) | 120.2 | 120.2 | No change |
| Melt Temperature (° F.) | 292 | 300 | +2.7% |
| Motor Load (A)-245 Max | 123 | 133 | +8.1% |
| Haul-Off Speed (ft/min) | 42.5 | 42.4 | No change |

### Examples 16-18 and C5-C6

In Table 14, Examples 16-18 are test values for inventive ethylene polymers that encompass and are representative of Examples 1-4 and Examples 7-10 described above. Thermal Stability was determined in accordance with ASTM D3350, heat deflection temperature (HDT) was determined in accordance with ASTM D648 (at 66 psi) as noted above, and Oxidative-Induction Time (OIT) was determined in accordance with ASTM D3895. Of particular note in Table 14, Examples 16-18 had Thermal Stability values over 250° C., HDT values in the 72-87° C. range, and OIT values of approximately 1 hr or more, and each of these values were much higher than that for Comparative Examples C5-C6.

TABLE 14
Properties of Examples 16-18

| | | | Heat | Oxidative- |
|---|---|---|---|---|
| | | Thermal | Deflection | Induction |
| | I₅ | Stability | Temperature | Time |
| Example | (g/10 min) | (° C.) | (° C.) | (min) |
| 16 | 1.39 | 252.3 | 86.9 | 66.1 |
| 17 | 1.49 | 250.6 | 74.8 | 58.9 |
| 18 | 1.48 | 251.5 | 72.9 | 67.8 |
| C5 | — | 246 | 58.0 | 21.6 |
| C6 | — | 239 | 68.5 | 20.7 |

The invention is described herein with reference to numerous aspects and specific examples. Many variations will suggest themselves to those skilled in the art in light of the detailed description. All such obvious variations are within the full intended scope of the appended claims. Other aspects of the invention can include, but are not limited to, the following (aspects are described as “comprising” but, alternatively, can “consist essentially of” or “consist of”):

Aspect 1. An ethylene polymer having (or characterized by) a melt index (MI) in a range from 0.15 to 0.5 g/10 min, a high load melt index (HLMI) in a range from 15 to 50 g/10 min, a density in a range from 0.94 to 0.96 g/cm³, and a higher molecular weight component and a lower molecular weight component, wherein the higher molecular weight component has (or is characterized by) a HMW HL275 in a range from 3 to 8 g/10 min and a HMW density in a range from 0.92 to 0.94 g/cm³.

Aspect 2. The polymer defined in aspect 1, wherein the melt index (MI) is in any range disclosed herein, e.g., from 0.15 to 0.45, from 0.15 to 0.4, from 0.2 to 0.5, from 0.2 to 0.4, from 0.2 to 0.35, from 0.25 to 0.5, from 0.25 to 0.45, from 0.25 to 0.4, from 0.27 to 0.5, from 0.27 to 0.45, from 0.27 to 0.4, or from 0.3 to 0.4 g/10 min.

Aspect 3. The polymer defined in aspect 1 or 2, wherein the high load melt index (HLMI) is in any range disclosed herein, e.g., from 15 to 45, from 15 to 40, from 20 to 50, from 20 to 45, from 20 to 40, from 25 to 50, from 25 to 45, from 25 to 40, from 27 to 45, or from 27 to 40 g/10 min.

Aspect 4. The polymer defined in any one of the preceding aspects, wherein the density is in any range disclosed herein, e.g., from 0.94 to 0.958, from 0.94 to 0.954, from 0.945 to 0.96, from 0.945 to 0.958, from 0.945 to 0.954, from 0.947 to 0.958, from 0.947 to 0.954, from 0.949 to 0.958, from 0.949 to 0.955, or from 0.949 to 0.953 g/cm³.

Aspect 5. The polymer defined in any one of the preceding aspects, wherein the HMW HL275 is in any range disclosed herein, e.g., from 3 to 7, from 3 to 6.5, from 3.5 to 7.5, from 3.5 to 7, from 3.5 to 6.5, from 4 to 7.5, from 4 to 7, from 4.2 to 8, from 4.2 to 7.5, from 4.2 to 7, from 4.2 to 6.5, from 4.5 to 8, from 4.5 to 7.5, from 4.5 to 7, from 4.5 to 6.5, or from 4.9 to 6.1 g/10 min.

Aspect 6. The polymer defined in any one of the preceding aspects, wherein the HMW density is in any range disclosed herein, e.g., from 0.92 to 0.935, from 0.925 to 0.94, from 0.925 to 0.938, from 0.925 to 0.935, from 0.928 to 0.94, from 0.928 to 0.938, from 0.928 to 0.935, from 0.93 to 0.94, from 0.93 to 0.938, or from 0.93 to 0.935 g/cm³.

Aspect 7. The polymer defined in any one of the preceding aspects, wherein the ethylene polymer has a ratio of HLMI/MI in any range disclosed herein, e.g., from 80 to 130, from 85 to 125, from 85 to 120, from 85 to 115, from 90 to 130, from 90 to 125, from 90 to 120, from 90 to 115, from 95 to 125, from 95 to 120, or from 95 to 115.

Aspect 8. The polymer defined in any one of the preceding aspects, wherein the ethylene polymer has a Mn in any range disclosed herein, e.g., from 7,000 to 16,000, from 8,000 to 15,000, from 9,000 to 15,000, from 9,000 to 14,000, or from 10,000 to 14,000 g/mol.

Aspect 9. The polymer defined in any one of the preceding aspects, wherein the ethylene polymer has a Mw in any range disclosed herein, e.g., from 150,000 to 280,000, from 150,000 to 250,000, from 150,000 to 225,000, from 160,000 to 260,000, from 160,000 to 240,000, from 160,000 to 220,000, from 170,000 to 260,000, from 170,000 to 220,000, from 180,000 to 250,000, from 180,000 to 225,000, or from 180,000 to 205,000 g/mol.

Aspect 10. The polymer defined in any one of the preceding aspects, wherein the ethylene polymer has a Mz in any range disclosed herein, e.g., from 700,000 to 1,900,000, from 800,000 to 1,800,000, from 850,000 to 1,750,000, from 900,000 to 1,700,000, from 950,000 to 1,650,000, or from 1,000,000 to 1,600,000 g/mol.

Aspect 11. The polymer defined in any one of the preceding aspects, wherein the ethylene polymer has a ratio of Mw/Mn in any range disclosed herein, e.g., from 10 to 20, from 11 to 20, from 11 to 19, from 12 to 20, from 12 to 19, from 12 to 18, from 13 to 20, from 13 to 19, or from 13 to 18.

Aspect 12. The polymer defined in any one of the preceding aspects, wherein the ethylene polymer has a ratio of Mz/Mw in any range disclosed herein, e.g., from 4 to 10, from 4 to 9, from 4 to 8, from 4.5 to 10, from 4.5 to 9, from 4.5 to 8.5, from 4.5 to 8, from 5 to 10, from 5 to 9, from 5 to 8, from 5.25 to 9, from 5.25 to 8, from 5.5 to 9, or from 5.5 to 8.

Aspect 13. The polymer defined in any one of the preceding aspects, wherein the ethylene polymer has an IB parameter in any range disclosed herein, e.g., from 1.7 to 2.4, from 1.7 to 2.3, from 1.7 to 2.2, from 1.8 to 2.3, from 1.8 to 2.2, from 1.8 to 2.1, from 1.9 to 2.3, from 1.9 to 2.2, from 2 to 2.4, from 2 to 2.3, from 2 to 2.2, or from 2 to 2.1.

Aspect 14. The polymer defined in any one of the preceding aspects, wherein the ethylene polymer has an environmental stress crack resistance (ESCR) in any range disclosed herein, e.g., at least 1,000 hr, at least 1,500 hr, at least 2,000 hr, at least 2,500 hr, at least 2,800 hr, at least 3,000 hr, or at least 3,500 hr (condition B, 10% Igepal).

Aspect 15. The polymer defined in any one of the preceding aspects, wherein the ethylene polymer has a zero-shear viscosity (no) in any range disclosed herein, e.g., from 40,000 to 140,000, from 50,000 to 130,000, from 50,000 to 110,000, from 50,000 to 100,000, from 60,000 to 120,000, from 60,000 to 100,000, from 60,000 to 90,000, or from 70,000 to 85,000 Pa-sec.

Aspect 16. The polymer defined in any one of the preceding aspects, wherein the ethylene polymer has a tan δ (tan d or tangent delta) at 0.1 sec⁻¹ in any range disclosed herein, e.g., from 1.8 to 3.2, from 2 to 3, from 2.1 to 2.8, from 2.1 to 2.7, from 2.2 to 2.7, from 2.3 to 2.7, or from 2.3 to 2.6 degrees.

Aspect 17. The polymer defined in any one of the preceding aspects, wherein the ethylene polymer has a tan δ (tan d or tangent delta) at 100 sec⁻¹ in any range disclosed herein, e.g., from 0.5 to 1, from 0.5 to 0.9, from 0.6 to 1, from 0.6 to 0.9, from 0.6 to 0.8, from 0.65 to 0.9, from 0.65 to 0.8, from 0.7 to 0.9, or from 0.7 to 0.8 degrees.

Aspect 18. The polymer defined in any one of the preceding aspects, wherein the ethylene polymer has a CY-a parameter in any range disclosed herein, e.g., from 0.18 to 0.33, from 0.2 to 0.32, from 0.2 to 0.3, from 0.22 to 0.3, from 0.24 to 0.3, from 0.24 to 0.28, or from 0.25 to 0.28.

Aspect 19. The polymer defined in any one of the preceding aspects, wherein the ethylene polymer has a relaxation time (Tau(eta) or τ(η)) in any range disclosed herein, e.g., from 0.1 to 0.8, from 0.2 to 0.7, from 0.2 to 0.6, from 0.3 to 0.7, from 0.3 to 0.6, or from 0.3 to 0.5 sec.

Aspect 20. The polymer defined in any one of the preceding aspects, wherein the ethylene polymer has a viscosity at 100 sec⁻¹ (eta@ 100 or η@100) in any range disclosed herein, e.g., from 1,000 to 1,800, from 1,100 to 1,700, from 1,100 to 1,600, from 1,100 to 1,500, from 1,200 to 1,800, from 1,200 to 1,700, from 1,200 to 1,600, from 1,200 to 1,500, from 1,300 to 1,700, from 1,300 to 1,600, or from 1,300 to 1,500 Pa-sec.

Aspect 21. The polymer defined in any one of the preceding aspects, wherein the ethylene polymer has a ratio of viscosity at 0.1 sec⁻¹ (eta@0.1 or η@0.1) to the viscosity at 100 sec⁻¹ (eta@100 or η@100) in any range disclosed herein, e.g., from 14 to 24, from 15 to 22, from 16 to 21, from 17 to 20, or from 18 to 19.

Aspect 22. The polymer defined in any one of the preceding aspects, wherein an amount of the lower molecular weight component (determined by deconvolution based on the total polymer) is in any range of weight percentages disclosed herein, e.g., from 40 to 60 wt. %, from 40 to 55 wt. %, from 42 to 55 wt. %, from 45 to 55 wt. %, or from 47 to 54 wt. %.

Aspect 23. The polymer defined in any one of the preceding aspects, wherein the higher molecular component has a Mw in any range disclosed herein, e.g., from 200,000 to 500,000, from 250,000 to 450,000, from 300,000 to 400,000, or from 320,000 to 380,000 g/mol.

Aspect 24. The polymer defined in any one of the preceding aspects, wherein the higher molecular weight component has a Mn in any range disclosed herein, e.g., from 25,000 to 55,000, from 30,000 to 50,000, from 33,000 to 47,000, from 35,000 to 45,000, or from 37,000 to 43,000 g/mol.

Aspect 25. The polymer defined in any one of the preceding aspects, wherein the higher molecular weight component has a ratio of Mw/Mn in any range disclosed herein, e.g., from 6 to 11, from 6 to 10, from 6 to 9, from 7 to 11, from 7 to 10, from 7 to 9, from 8 to 11, from 8 to 10, or from 8 to 9.

Aspect 26. The polymer defined in any one of the preceding aspects, wherein the lower molecular weight component has a Mw in any range disclosed herein, e.g., from 25,000 to 50,000, from 30,000 to 45,000, from 30,000 to 40,000, from 35,000 to 45,000, or from 35,000 to 40,000 g/mol.

Aspect 27. The polymer defined in any one of the preceding aspects, wherein the lower molecular weight component has a ratio of Mw/Mn in any range disclosed herein, e.g., from 4 to 8, from 4.5 to 7.5, from 4.5 to 7, from 5 to 7.5, from 5 to 7, from 5.5 to 7.5, from 5.5 to 7, from 5.5 to 6.5, or from 5.8 to 6.2.

Aspect 28. The polymer defined in any one of the preceding aspects, wherein an amount of the higher molecular weight component (determined by ethylene consumption in the first reactor versus total ethylene consumption) is in any range of weight percentages disclosed herein, e.g., from 40 to 60 wt. %, from 42 to 58 wt. %, from 42 to 55 wt. %, from 42 to 52 wt. %, or from 45 to 55 wt. %.

Aspect 29. The polymer defined in any one of the preceding aspects, wherein the higher molecular weight component has a (calculated) HLMI in any range disclosed herein, e.g., from 0.9 to 2.5, from 1 to 2.4, from 1.1 to 2.3, from 1.3 to 2.2, from 1.3 to 2, from 1.4 to 2.2, from 1.4 to 2, from 1.5 to 2.2, or from 1.5 to 2 g/10 min.

Aspect 30. The polymer defined in any one of the preceding aspects, wherein the lower molecular weight component has a (calculated) density in any range disclosed herein, e.g., from 0.96 to 0.975, from 0.96 to 0.973, from 0.962 to 0.975, from 0.962 to 0.973, from 0.965 to 0.975, or from 0.965 to 0.973 g/cm³.

Aspect 31. The polymer defined in any one of the preceding aspects, wherein the lower molecular weight component has a (calculated) HLMI in any range disclosed herein, e.g., from 800 to 3,000, from 800 to 2,500, from 1,000 to 3,000, from 1,000 to 2,800, from 1,000 to 2,500, from 1,200 to 2,600, or from 1,400 to 2,400 g/10 min.

Aspect 32. The polymer defined in any one of the preceding aspects, wherein the ethylene polymer has a yield strength in any range disclosed herein, e.g., from 3,000 to 5,000, from 3,300 to 4,700, from 3,500 to 4,500, from 3,500 to 4,200, from 3,700 to 4,500, or from 3,700 to 4,100 psi (ASTM D638 Tensile).

Aspect 33. The polymer defined in any one of the preceding aspects, wherein the ethylene polymer has an elongation at break in any range disclosed herein, e.g., from 700 to 1,000, from 700 to 950, from 750 to 950, from 800 to 1,000, from 800 to 950, or from 800 to 900% (ASTM D638 Tensile).

Aspect 34. The polymer defined in any one of the preceding aspects, wherein the ethylene polymer has a tensile modulus in any range disclosed herein, e.g., from 200,000 to 300,000, from 200,000 to 280,000, from 220,000 to 300,000, or from 220,000 to 280,000 psi (ASTM D638 Tensile).

Aspect 35. The polymer defined in any one of the preceding aspects, wherein the ethylene polymer has a tangent modulus in any range disclosed herein, e.g., from 150,000 to 250,000, from 170,000 to 230,000, from 180,000 to 220,000, or from 190,000 to 210,000 psi (ASTM D790 Flexural).

Aspect 36. The polymer defined in any one of the preceding aspects, wherein the ethylene polymer has a flexural modulus (2% secant) in any range disclosed herein, e.g., from 100,000 to 180,000, from 125,000 to 175,000, from 140,000 to 160,000, or from 145,000 to 155,000 psi (ASTM D790 Flexural).

Aspect 37. The polymer defined in any one of the preceding aspects, wherein the ethylene polymer has a NCLS in any range disclosed herein, e.g., from 80 to 1,000, from 80 to 800, from 100 to 1,000, from 100 to 800, from 150 to 1,000, from 150 to 800, or from 150 to 700 hr (ASTM F2136); additionally or alternatively, the ethylene polymer has a SHM in any range disclosed herein, e.g., from 20 to 40, from 25 to 40, from 25 to 38, from 25 to 35, from 28 to 40, from 28 to 35, from 30 to 40, from 30 to 38, or from 30 to 35 MPa (ISO 18488); additionally or alternatively, the ethylene polymer has a FNCT in any range disclosed herein, e.g., at least 100 hr, at least 200 hr, at least 500 hr, at least 1000 hr, at least 5,000 hr, at least 10,000 hr, or at least 25,000 hr (ISO 16770, a test temperature of 50° C. and a test force or pressure of 9 MPa, or a test temperature of 80° C. and a test force of pressure of 6 MPa, or any other combination of test conditions disclosed herein).

Aspect 38. The polymer defined in any one of the preceding aspects, wherein the ethylene polymer has a HDT in any range disclosed herein, e.g., from 60 to 90° C., from 60 to 85° C., from 65 to 90° C., from 65 to 85° C., from 70 to 90° C., or from 70 to 85° C. (ASTM D648).

Aspect 39. The polymer defined in any one of the preceding aspects, wherein the ethylene polymer has a thermal stability in any range disclosed herein, e.g., from 240 to 270° C., from 240 to 260° C., from 240 to 255° C., from 245 to 265° C., from 245 to 255° C., or from 250 to 255° C. (ASTM D3350).

Aspect 40. The polymer defined in any one of the preceding aspects, wherein the ethylene polymer has an oxidative-induction time (OIT) in any range disclosed herein, e.g., from 50 to 90 min, from 50 to 75 min, from 55 to 85 min, from 55 to 75 min, or from 55 to 70 min (ASTM D3895).

Aspect 41. The polymer defined in any one of the preceding aspects, wherein the ethylene polymer has an I₅ in any range disclosed herein, e.g., from 0.8 to 2.4, from 1 to 2.2, from 1 to 2, from 1 to 1.8, from 1.1 to 2.2, from 1.1 to 2, from 1.1 to 1.9, from 1.2 to 2, from 1.2 to 1.9, from 1.2 to 1.8, from 1.3 to 2.2, from 1.3 to 2, from 1.3 to 1.9, or from 1.3 to 1.8 g/10 min.

Aspect 42. The polymer defined in any one of the preceding aspects, wherein the ethylene polymer contains, independently, less than 0.1 ppm (by weight), less than 0.08 ppm, less than 0.05 ppm, or less than 0.03 ppm, of Hf, Zr, or Cr.

Aspect 43. The polymer defined in any one of the preceding aspects, wherein the ethylene polymer has a bimodal molecular weight distribution.

Aspect 44. The polymer defined in any one of the preceding aspects, wherein the ethylene polymer comprises an ethylene/α-olefin copolymer.

Aspect 45. The polymer defined in any one of the preceding aspects, wherein the ethylene polymer comprises an ethylene homopolymer, an ethylene/1-butene copolymer, an ethylene/1-hexene copolymer, and/or an ethylene/1-octene copolymer.

Aspect 46. The polymer defined in any one of the preceding aspects, wherein the ethylene polymer comprises an ethylene/1-hexene copolymer.

Aspect 47. A polymer composition comprising the ethylene polymer defined in any one of the preceding aspects and any suitable amount of a post-consumer recycle (PCR) and/or post-industrial recycle (PIR) resin.

Aspect 48. An article comprising the ethylene polymer or the polymer composition defined in any one of the preceding aspects.

Aspect 49. An article comprising the ethylene polymer or the polymer composition defined in any one of aspects 1-47, wherein the article is an agricultural film, an automobile part, a bottle, a container for chemicals, a drum, a dunnage bag, a fiber or fabric, a food packaging film or container, a food service article, a fuel tank, a geomembrane, a household container, a liner, a molded product, a medical device or material, an outdoor storage product, outdoor play equipment, a pipe, a sheet or tape, a toy, or a traffic barrier.

Aspect 50. An article comprising the ethylene polymer or the polymer composition defined in any one of aspects 1-47, wherein the article is a wire, a cable, or a conduit pipe.

What is claimed is:

1. An ethylene polymer having:
a melt index (MI) in a range from 0.15 to 0.5 g/10 min;
a high load melt index (HLMI) in a range from 15 to 50 g/10 min;
a density in a range from 0.94 to 0.96 g/cm³; and
a higher molecular weight component (HMW) and a lower molecular weight (LMW) component, wherein the higher molecular weight component has (or is characterized by):
a HMW HL275 in a range from 3 to 8 g/10 min; and
a HMW density in a range from 0.92 to 0.94 g/cm³.

2. The polymer of claim 1, wherein:
the melt index (MI) is in a range from 0.25 to 0.45 g/10 min;
the high load melt index (HLMI) is in a range from 20 to 45 g/10 min;
the density is in a range from 0.947 to 0.958 g/cm³;
the HMW HL275 is in a range from 4.2 to 7 g/10 min; and
the HMW density is in a range from 0.925 to 0.935 g/cm³.

3. The polymer of claim 1, wherein the ethylene polymer has:
an environmental stress crack resistance (ESCR) of at least 1,000 hr (ASTM D1693, condition B, 10% Igepal);
a viscosity at 100 sec⁻¹ (eta@100 or η@100) in a range from 1,000 to 1,800 Pa-sec;
a notched constant ligament stress (NCLS) in a range from 80 to 1,000 hr (ASTM F2136); or
any combination thereof.

4. The polymer of claim 1, wherein the ethylene polymer has an environmental stress crack resistance (ESCR) of at least 2,800 hr (ASTM D1693, condition B, 10% Igepal).

5. The polymer of claim 1, wherein the ethylene polymer has a viscosity at 100 sec⁻¹ (eta @100 or η@100) in a range from 1,200 to 1,600 Pa-sec.

6. The polymer of claim 1, wherein the ethylene polymer has:
a notched constant ligament stress (NCLS) in a range from 150 to 800 hr (ASTM F2136);
a full-notch creep test (FNCT) of at least 200 hr at a test temperature of 50° C. and a test force or pressure of 9 MPa (ISO 16770);
a full-notch creep test (FNCT) of at least 200 hr at a test temperature of 80° C. and a test force or pressure of 6 MPa (ISO 16770); or
any combination thereof.

7. The polymer of claim 1, wherein the ethylene polymer has a yield strength in a range from 3,000 to 5,000 psi (ASTM D638 Tensile).

8. The polymer of claim 1, wherein the ethylene polymer has a tensile modulus in a range from 200,000 to 300,000 psi (ASTM D638 Tensile).

9. The polymer of claim 1, wherein the ethylene polymer has:
a ratio of HLMI/MI in a range from 80 to 130;
an I₅ in a range from 1 to 2.2 g/10 min; or
both.

10. The polymer of claim 1, wherein the ethylene polymer has:
a Mn in a range from 7,000 to 16,000 g/mol;
a Mw in a range from 150,000 to 280,000 g/mol; and
a Mz in a range from 700,000 to 1,900,000 g/mol.

11. The polymer of claim 1, wherein the ethylene polymer has:
a tan δ (tan d or tangent delta) at 0.1 sec⁻¹ in a range 1.8 to 3.2 degrees;
a tan δ (tan d or tangent delta) at 100 sec⁻¹ in a range from 0.5 to 1 degrees;
a CY-a parameter in a range from 0.18 to 0.33;
a relaxation time (Tau(eta) or τ(η)) in a range from 0.1 to 0.8 sec; or
any combination thereof.

12. The polymer of claim 1, wherein the ethylene polymer has:
a tan δ (tan d or tangent delta) at 0.1 sec⁻¹ in a range 2.2 to 2.7 degrees;
a tan δ (tan d or tangent delta) at 100 sec⁻¹ in a range from 0.65 to 0.8 degrees;
a CY-a parameter in a range from 0.2 to 0.32; and
a relaxation time (Tau(eta) or τ(η)) in a range from 0.3 to 0.7 sec.

13. The polymer of claim 1, wherein:
the melt index (MI) is in a range from 0.2 to 0.5 g/10 min;
the high load melt index (HLMI) is in a range from 25 to 40 g/10 min;
the density is in a range from 0.947 to 0.954 g/cm³;
the HMW HL275 is in a range from 4.2 to 6.5 g/10 min; and
the HMW density is in a range from 0.925 to 0.938 g/cm³.

14. The polymer of claim 13, wherein the ethylene polymer has:
a Mn in a range from 7,000 to 16,000 g/mol;
a Mw in a range from 150,000 to 225,000 g/mol; and
a Mz in a range from 700,000 to 1,900,000 g/mol.

15. The polymer of claim 13, wherein the ethylene polymer has:
a ratio of Mw/Mn in a range from 12 to 20; and
a ratio of Mz/Mw in a range from 5 to 9.

16. The polymer of claim 13, wherein:
the higher molecular weight component is further characterized by a HMW Mw/Mn in a range from 6 to 11; and
the lower molecular weight component is characterized by a LMW Mw/Mn in a range from 4.5 to 7.5 and a LMW density in a range from 0.962 to 0.975 g/cm³.

17. The polymer of claim 1, wherein the ethylene polymer has:
a strain hardening modulus (SHM) in a range from 20 to 40 MPa (ISO 18488);
a heat deflection temperature (HDT) in a range from 70 to 90° C. (ASTM D648);
a thermal stability in a range from 240 to 260° C. (ASTM D3350);
an oxidative-induction time (OIT) in a range from 50 to 75 min (ASTM D3895); or
any combination thereof.

18. The polymer of claim 1, wherein the ethylene polymer comprises an ethylene homopolymer, an ethylene/1-butene copolymer, an ethylene/1-hexene copolymer, and/or an ethylene/1-octene copolymer.

19. The polymer of claim 1, wherein the ethylene polymer contains, independently, less than 0.1 ppm by weight of hafnium, zirconium, and chromium.

20. A polymer composition comprising the polymer of claim 1 and a post-consumer recycle (PCR) resin and/or a post-industrial recycle (PIR) resin.

21. An article comprising the ethylene polymer of claim 1.

22. The article of claim 21, wherein the article is a wire, a cable, or a conduit pipe.
